(19) United States
(12) Patent Application Publication
(10) Pub. No.: US 2017/0299935 A1
(43) Pub. Date: Oct. 19, 2017

(54) DISPERSIVE PERIODIC CONCENTRATOR

(71) Applicant: CLEARink Displays, Inc., FREMONT, CA (US)

(72) Inventor: Lorne A. WHITEHEAD, Vancouver (CA)

(21) Appl. No.: 15/526,001

(22) PCT Filed: Nov. 23, 2015
(86) PCT No.: PCT/US15/62075

§ 371 Date: May 11, 2017

Related U.S. Application Data
(60) Provisional application No. 62/083,371, filed on Nov. 24, 2014.

(51) Int. Cl. G02F 1/167; G02F 1/19; G02F 1/1335

(52) U.S. Cl. CPC G02F 1/167; G02F 1/195; G02F 1/133514

(57) ABSTRACT

The disclosure generally relates to image displays. Specifically, the application relates to an overlay that, among others, enhances the brightness in image displays with color filters. Much of the incoming light to a reflective image display having a color filter layer is absorbed by the color filter layer and is therefore lost. An overlay embodiment is disclosed herein that disperses and concentrates portions of the incoming light onto specific portions of the display. The amount of light absorbed by the color filter layer may be drastically reduced and instead transmitted through the color filter where the light may be reflected or absorbed by a light modulating layer. The disclosed embodiments increase the efficiency and reflectance of the display.

This application claims priority to the filing date of PCT Application No. PCT/US2015/062075, filed Nov. 23, 2015, which claims priority to Provisional Application No. 62/083,371, filed Nov. 24, 2014. The specification of each of the prior-file applications is incorporated herein in its entirety.

### FIELD

The disclosure generally relates to image displays. Specifically, the application relates to an overlay that, among others, enhances the brightness in image displays with color filters.

### BACKGROUND

Color reflective displays typically comprise a color filter layer made up of red, green and blue (RGB) filters. The filters are positioned above a controllable modulating reflector assembly. The assembly absorbs the incident light or reflects the light back through the filter and towards the viewer viewing the display. One problem with color filters is that as much as ⅔ of the visible spectrum is absorbed by the color filter whereas the other about ⅓ of the visible spectrum is transmitted. This effect greatly lowers the efficiency and brightness of the display. For example in a display with a RGB color filter array, the red and green light is absorbed by a blue filter, the red and blue light is absorbed by a green filter and the blue and green light is absorbed by a red filter such that about ⅔ of the light is absorbed. Additionally, red light (or light corresponding to this wavelength) is transmitted through a red filter, green light is transmitted through a green filter and blue light is transmitted through a blue filter such that about ⅓ of the light is transmitted. The transmitted light is reflected through their respective same color filter back towards the viewer.

It is preferred that all light is dispersed and concentrated onto filters of the same color such that the absorption of light by different colored filters is minimized and the transmission of light is maximized to increase the efficiency and brightness of the display.

### BRIEF DESCRIPTION OF DRAWINGS

These and other embodiments of the disclosure will be discussed with reference to the following exemplary and non-limiting illustrations, in which like elements are numbered similarly, and where:

FIG. 1 is a schematic illustration of a cross section of a periodic concentrator overlay;

FIG. 2 illustrates a cross section of a portion of a micro-capsule-based reflective display according to one embodiment of the disclosure;

FIG. 3 schematically illustrates a cross section of a portion of a total internal reflection (TIR)-based reflective display according to one embodiment of the disclosure; and

FIG. 4 schematically illustrates an exemplary system for implementing an embodiment of the disclosure.

### DETAILED DESCRIPTION

The exemplary embodiments provided herein improve display efficiency of electronic displays. In an exemplary embodiment, the disclosure provides an overlay placed adjacent to the color filter layer facing the viewer. For incident light within about 30° of the normal direction, the overlay disperses light and concentrates, among others, red light rays onto a red filter, green light rays onto a green filter and blue light rays onto a blue filter. The filter enable the colored light that is reflected back through the same color filter to return towards the viewer. As a result efficiency and reflectance properties of the display increase.

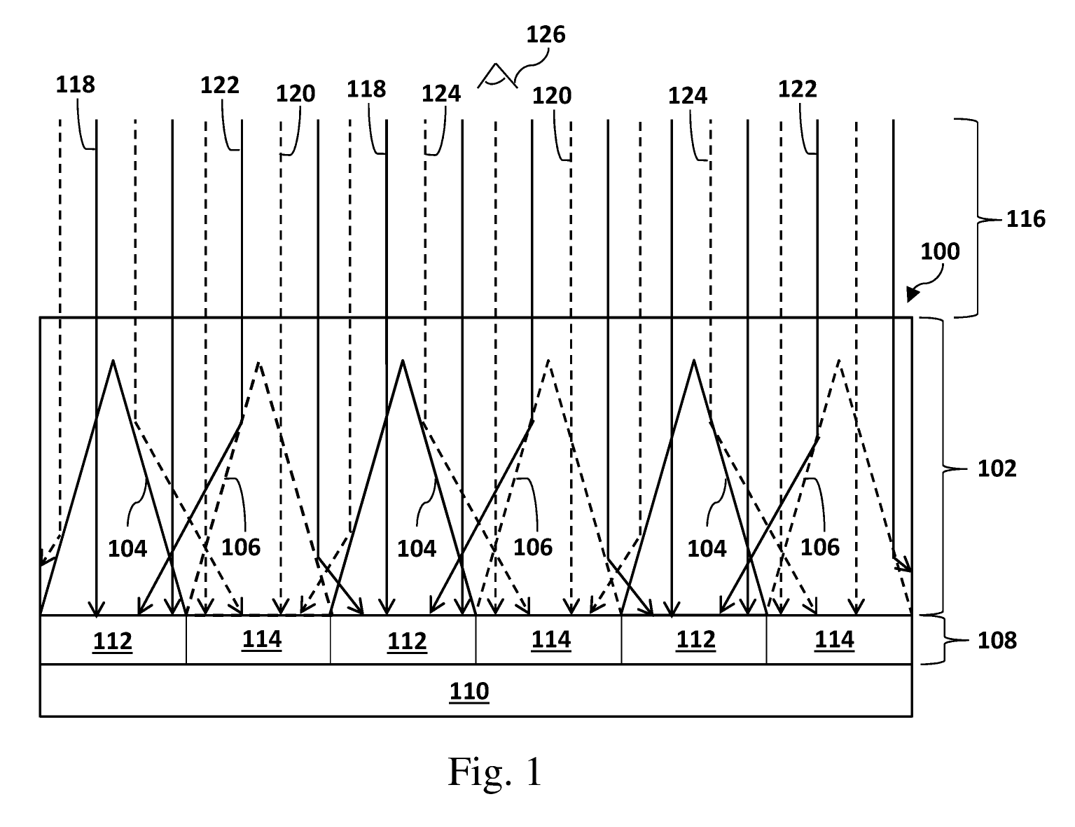

FIG. 1 is a schematic illustration of a cross section of a periodic concentrator overlay system. The periodic concentrator display 100 illustrated in FIG. 1 comprises a periodic concentrator overlay 102. The periodic concentrator overlay layer 102 may further comprise a plurality of optical filter elements 104, 106. Optical filter elements may also be referred to as mirror elements. The optical filter elements may be arranged in a periodic array and may be substantially aligned or registered with the plurality of color filters of the color filter layer 108. The optical filter elements may transmit a portion of the light while reflecting the remaining portion of the light. Optical filter elements 104 denoted by solid lines, for example, may be configured to transmit blue light while reflecting yellow and other color light. Optical filter element 106 denoted by dashed lines, for example, may be capable of transmitting yellow light while reflecting blue light. In an exemplary embodiment, overlay layer 102 may comprise three optical filter elements arranged in a substantially periodic array and aligned with the plurality of filters in a color filter array layer.

In one embodiment, the optical filter elements may comprise dichroic mirrors. They may also comprise, for example, dichroic filters, interference filters, thin-film filters or dichroic reflectors. The overlay may also comprise photonic crystal components or holographic-based components such as a layer of holographic lenses substantially aligned with the color filter array 108. Regardless of the type of filter, mirror or reflector or other system used, they may operate similarly in which they selectively transmit or reflect light as a function of wavelength. In other words, some wavelengths of light are transmitted while other wavelengths of light are reflected. In an exemplary implementation, the optical filters comprise multi-layered structures including alternating layers of high and low refractive index coatings. The properties may be tuned by controlling the thickness and number of layers.

In the periodic concentrator overlay 102 of FIG. 1, the optical filter elements are depicted as angled reflectors in the shape of elongated triangles. It should be noted that FIG. 1 and the remaining figures are illustrative in nature and other shapes may be used without departing from the disclosed principles as there are many optical designs that may produce periodic concentration at a location that is wavelength dependent.

FIG. 1 also shows a color filter layer 108. In order to better understand the invention and to make the cross section drawing clearer in FIG. 1, an embodiment will be described in the case of color filters of two colors. Typically three colors make up a color filter layer such as the conventional combinations of red, green, blue (RGB) or cyan, magenta, yellow (CMY). In the example in FIG. 1, a color filter layer 108 comprising of a plurality of blue color filters 112 and yellow color filters 114 will be described. Furthermore, for simplicity only the incident light (and not the reflected light) from the light-modulating layer 110 is shown.

Color filter layer 104 may comprise individual blue 112 and yellow 114 color filters. These two colors may be chosen to illustrate the concept as yellow filters absorb blue light and blue filters absorb yellow light (other color combinations may be envisioned). Using two colors further simplifies the description of the concept as all reflected light will be reflected towards adjacent filters of the same color and may be transmitted. Thus the transmitted light is not absorbed (i.e., lost) by a color filter as will be described forthwith.

In some embodiments the color filter layer may further comprise polarizers to enhance efficiency in conjunction with a liquid crystal display.

Display 100 in FIG. 1 comprises light-modulating layer 110. The light-modulating layer may be controlled by a voltage or current source (not shown). The light-modulating layer may absorb or reflect light that passes through the color filter layer 108 in a controllable manner.

FIG. 1 also shows a plurality of light rays 116 incident on the periodic overlay 102. For illustrative purposes, the light rays have been separated into blue and yellow light rays where the blue light rays 118, 122 are denoted by solid lines and the yellow light rays 120, 124 are denoted by dashed lines. For further clarity, blue light rays 118, 122 and the optical filter elements 104 that transmit blue light are both denoted by a solid line. Each optical filter element can be an optical filter, such as, a dichroic mirror. The yellow light rays 120, 124 and the optical filter elements 106 that may transmit yellow light are both denoted by a dashed line. For descriptive purposes, the blue light rays 118, 122 have been separated into transmitted blue light rays 118 and reflected blue light rays 122. The yellow light rays 120, 124 have been separated into transmitted light rays 120 and reflected light rays 124.

As blue light rays 118 enter the periodic concentrator overlay 102, some of the blue light rays 118 are incident on the optical filter elements 104 where the blue light rays are transmitted through the optical filter elements 104 that transmit blue light. Rays 118 pass through the blue color filters 112. Other blue light rays 122 are incident on the optical filter elements 106 that only transmit yellow light but substantially reflect the blue light 122. These reflectors 106 prevent the blue light from being absorbed by the yellow color filters 114 by reflecting the blue light rays towards adjacent optical filter elements 104 that transmit blue light. The blue light is concentrated and passes through the blue color filters 112 leading to enhanced efficiency and brightness of the display. As a result, less light is lost through absorption by the color filter layer 108.

As yellow light rays 120, 124 enter the periodic concentrator overlay 102, some of the yellow light rays 120 may be incident on the optical filter elements 106 that transmit yellow light. The yellow light may be allowed to pass through the yellow color filters 114. Other yellow light rays 124 may be incident on the optical filter elements 104 that only transmit blue light but reflect the yellow light. These reflectors 104 prevent the yellow light from being absorbed by the blue color filters 112 by reflecting the yellow light rays towards adjacent optical filter elements 106 that transmit yellow light. The yellow light may be concentrated and pass through the yellow color filters 114 leading to enhanced efficiency and brightness of the display. As a result less light may be lost by absorption by the color filter layer 108. Optical filter elements 104, 106 concentrates the blue light towards the blue color filters 112 and concentrates the yellow light towards the yellow color filters 114. When the concentrated light passes through the color filter layer 108 it may be absorbed or reflected by the light modulation layer 110. The reflected light may be substantially reflected back through the color filter layer 108 towards viewer 126. The light reflected by the light modulation layer 110 is not shown in FIG. 1.

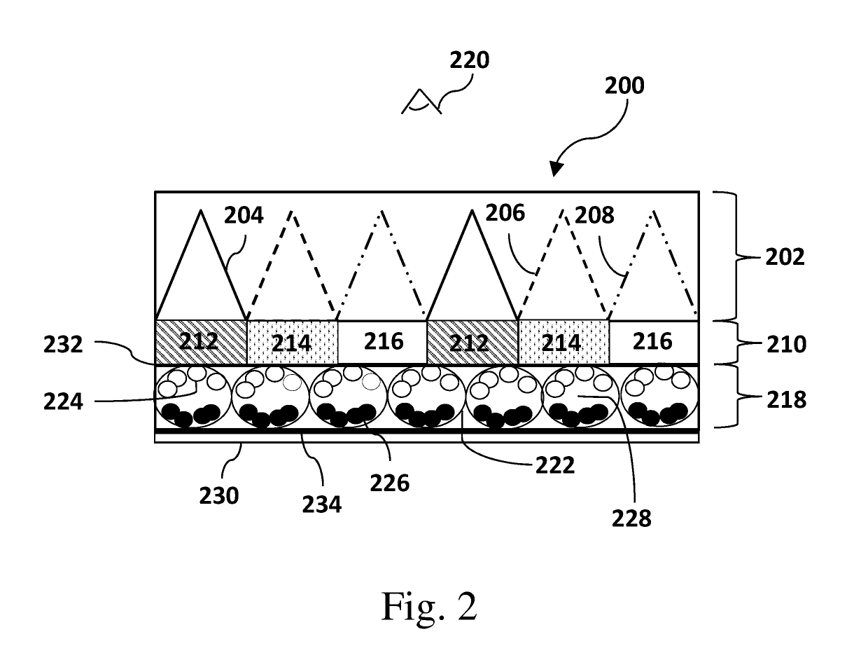

FIG. 2 illustrates a cross section of a portion of a micro-capsule-based reflective display according to one embodiment of the disclosure. Display 200 in FIG. 2 comprises a first periodic concentrator overlay layer 202. Layer 202 further comprises a plurality of optical filter elements 204, 206, 208. Display 200 comprises color filter layer 210 having an array of red 212, green 214 and blue 216 color filters. In some embodiments layer 210 may comprise an array of cyan, magenta and yellow (CMY) color filters. In some embodiments, display 200 may only have two optical filter elements matched with a color filter layer comprising two color filters corresponding to the two colors. Layer 210 may be any desired combination of color filters. Moreover, layer 210 may have multiple sublayers and is not limited to one layer.

In display 200, the overlay layer 202 may comprise of optical filter element 204 denoted by solid lines and aligned with a red color filter 212 that substantially transmits red light but substantially reflects green and blue light. Overlay layer 202 may further comprise optical filter element 206 denoted by dashed lines, which aligns with a green color filter 214 that substantially transmits green light but substantially reflects red and blue light. The overlay layer 202 may further comprise of optical filter element 208 denoted by dot-dashed lines (•• - •• -) and registered with a blue color filter 216 that substantially transmits blue light but substantially reflects red and green light. In some embodiments display 200 may further comprise at least one polarizer to enhance color saturation.

It should be noted that the three-color filter design as illustrated in FIG. 2 may not generate the same enhancement as the two-color design embodiment illustrated in FIG. 1. In the simplified two-color embodiment shown in FIG. 1, the reflectance enhancement may be substantially maximized as the yellow light is redirected towards adjacent yellow color filters and the blue light is redirected towards adjacent blue color filters. For example, when red light is incident on the left side of a green optical filter element 206 as shown in FIG. 2, the red light may be redirected towards an adjacent red color filter 212 where the red light may be transmitted through the red color filter 212 and increase reflectance. When red light is incident on the right side of a green optical filter element 206, the red light may be redirected towards the adjacent blue color filter 216 where the red light may be absorbed and will not increase reflectance. In another scenario, when green light is incident on the left side of a red optical filter element 204, the green light may be redirected towards the adjacent blue color filter 216 where the light may be absorbed and not increase reflectance. When green light is incident on the right side of a red optical filter element 204, the green light may be redirected to an adjacent green color filter 214 where the green light may be transmitted through the green color filter 214 and increase reflectance.

The display embodiment in FIG. 2 further shows light-modulating layer 218. Layer 218 may absorb light transmitted through the color filter layer 210 or reflect the light back through the color filter layer 210 towards viewer 220. In this embodiment light-modulating layer 218 may be comprised of a plurality of microcapsules 222. The microcapsules 222 may further comprise a plurality of light reflecting electrophoretically mobile particles 224 and light absorbing electrophoretically mobile particles 226 suspended in a liquid medium 228. Particles 224 and 226 are charged with opposite polarity. In an exemplary embodiment, particles 224 may comprise titanium dioxide (TiO₂) and particles 226 may comprise carbon black or a metal oxide-based pigment. In other embodiments, the microcapsules 222 may comprise light reflecting electrophoretically mobile particles in a light absorbing liquid medium. In another embodiment, electrophoretic particles may be suspended in medium 228 within light modulating layer 218 without having microcapsules.

Display 200 may comprise a rear support layer 230. Light-modulating layer 218 may comprise at least one electrode layer 234. In one exemplary embodiment, rear electrode 234 may be integrated with support layer 230. Front electrode 232 may be transparent and comprises indium tin oxide (ITO), conducting polymer or metallic nanoparticles dispersed in a clear polymer matrix. Rear electrode layer 234 may be located behind the layer of microcapsules. In another embodiment, rear electrode layer 234 may be interposed between rear support layer 230 and layer of microcapsules 222.

In an exemplary embodiment display 200 may comprise a voltage source (not shown) coupled to electrodes 232 and 234. The voltage source may be used to apply a voltage bias across the light-modulating layer 218.

In some embodiments display 200 may comprise at least one dielectric layer. The dielectric layer may be used to protect components of the display. In an exemplary embodiment display 200 may comprise a dielectric layer on one or both of the front and rear electrode layers. The dielectric layer may comprise one or more of SiO₂, parylene, a halogenated parylene or other polymer.

In an exemplary implementation, display 200 may be operated as follows. Applying a first voltage of one polarity to an electrode, at least one of light reflecting electrophoretically mobile particles 224 may be moved near the color filter layer 210 to reflect light that may be transmitted through the color filter layer 210. The reflected light may be reflected back through layer 210 towards the viewer 220 to create a light or bright state of the display. Applying a second voltage of opposite polarity to an opposing electrode at least one of light absorbing electrophoretically mobile particles 226 may be moved near the color filter layer 210 (not shown). At this location particles 226 may absorb light transmitted through the color filter layer 210 to create a dark state of the display—that is, light is not reflected back towards viewer 220. In an exemplary embodiment, each segment of light modulation layer 218 substantially corresponding to a color filter of layer 210 may be controlled independently by the rear electrode layer 234.

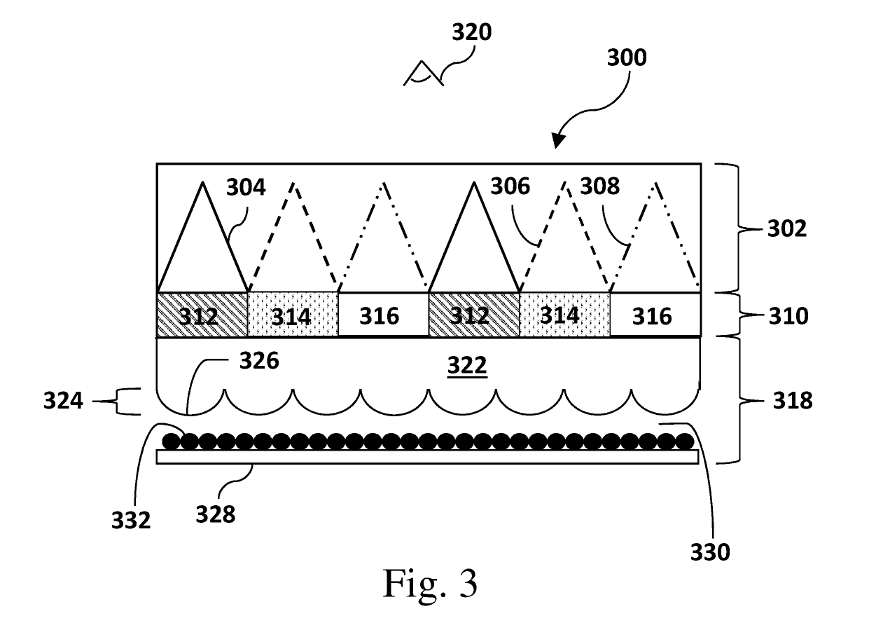

FIG. 3 schematically illustrates a cross section of a portion of a total internal reflection (TIR)-based reflective display according to one embodiment of the disclosure. Display 300 in FIG. 3 comprises a first periodic concentrator overlay layer 302. Layer 302 further comprises a plurality of optical filter elements 304, 306, 308. Display 300 includes a color filter layer 310 comprising an array of red 312, green 314 and blue 316 color filters. Other color filters may be included without departing from the disclosed principles. In some embodiments, layer 310 may comprise an array of CMY color filters. In some embodiments, display 300 may only have two optical filter elements each substantially aligned with color filters of a corresponding color filter layer. Layer 310 may be any desired combination of color filters.

In display 300, first periodic concentrator layer (overlay) 302 may comprise a first optical filter element 304 substantially aligned with a red color filter 312 that may transmit red light but reflects green and blue light. The overlay layer 302 may further comprise an optical filter element 306 aligned with a green color filter 314 that may transmit green light but reflects red and blue light. The overlay layer 302 may further comprise an optical filter element 308 aligned with a blue color filter 316 that may transmit blue light but reflects red and green light. In some embodiments, display 300 may further comprise at least one polarizer (not shown) to enhance color saturation.

Display 300 in FIG. 3 further comprises a light-modulating layer 318. Layer 318 may absorb light transmitted through the color filter layer 310 or reflect the light back through color filter layer 310 towards viewer 320. In display 300, light-modulating layer 318 is capable of TIR to create a light state. TIR may be frustrated to absorb incident light and to create a dark state. Light-modulating layer 318 may further comprise a high refractive index transparent sheet 322. Sheet 322 may further comprise a plurality of convex protrusions 324.

A transparent front electrode 326 may be located on the surface of the convex protrusions. In certain embodiments, the transparent electrode may be integrated with transparent sheet 322. Front electrode 326 may comprise one or more of indium tin oxide (ITO), a conducting polymer or metallic nanoparticles dispersed in a clear polymer matrix.

Light-modulating layer 318 may further comprise rear support 328 layer. Rear support layer 328 may further comprise a rear electrode layer (not shown). In one embodiment, the rear electrode may be positioned on the inward side, facing the plurality of convex protrusions 324.

Situated between rear support layer 328 and plurality of convex protrusions 324 is a low refractive index liquid medium 330. Medium 330 may be air or a liquid. Medium 330 may be a hydrocarbon. In an exemplary embodiment, medium 330 may be a fluorinated hydrocarbon.

Medium 330 is shown with a plurality of suspended electrophoretically mobile light absorbing particles 332. Particles 332 may be positively or negatively charged. Particles 332 may be dyes or pigments. In some embodiments particles 332 may be a metal oxide-based pigment. In other embodiments particles 332 may be a dye. In still other embodiments particles 332 may be a carbon-based pigment.

The light-modulating layer 318 may be controlled by a voltage source (not shown) coupled to the opposing electrodes. A bias may be applied across the liquid medium 330 comprising of particles 332 by the opposing electrode layers (not shown).

Display 300 may further comprise at least one dielectric layer (not shown). The dielectric layer may comprise one or more of an organic polymer or an inorganic layer such as SiO₂. In an exemplary embodiment display 300 comprises a dielectric layer on one or both of the front and rear electrodes. In an exemplary embodiment the at least one dielectric layer is parylene. In other embodiments, the dielectric layer may be a halogenated parylene.

Display 300 may be operated as follows. By applying a first bias of one polarity at the front electrode, the light absorbing electrophoretically mobile particles 332 with a charge of opposite polarity may be moved towards the front electrode 326. The particles 332 may enter the evanescent wave region near the surface of the plurality of convex protrusions 324. In this region, TIR may be frustrated such that incident light that passes through the color filter layer 310 may be absorbed to create a dark state. Applying a voltage of opposite polarity at the rear electrode, the light absorbing electrophoretically mobile particles 332 may be moved out of the evanescent wave region towards the rear electrode located on the rear support layer 328. Incident light that is transmitted through the overlay 302 and color filter layer 310 may be totally internally reflected back through layers 302, 310 towards the viewer 320 viewing the display. This creates a light or bright state of the display.

In another embodiment, the light-modulating layer 318 in display 300 may comprise a liquid crystal system. The liquid crystal system may be used to modulate the light that may pass through the color filter layer 310. In another embodiment, the light-modulating layer 318 in display 300 may comprise a micro-electro-mechanical system (MEMS). The MEMS may be used to modulate the light that may pass through the color filter layer 310. In another embodiment, the light-modulating layer 318 in display 300 may comprise an electro-wetting system. The electro-wetting system may be used to modulate the light that may pass through color filter layer 310. In another embodiment, the light-modulating layer 318 in display 300 may comprise an electro-fluidic system. The electro-fluidic system may be used to modulate the light that may pass through the color filter later 310.

In other embodiments, any of the image displays comprising a periodic concentrator overlay may further include at least one spacer structure. Spacer structures may be used in order to control the gap between the front and rear electrodes. Spacer structures may be used to support the various layers in the displays. The spacer structures may be in the shape of circular or oval beads, blocks, cylinders or other geometrical shapes or combinations thereof. The spacer structures may comprise glass, metal, plastic or other resin.

In other embodiments, any of the image displays comprising a periodic concentrator overlay may further include at least one edge seal. An edge seal may be a thermally or photo-chemically cured material. The edge seal may comprise one or more of an epoxy, silicone or other polymer based material.

In other embodiments, the image displays comprising a periodic concentrator overlay may further include at least one sidewall (may also be referred to as cross-walls). Sidewalls limit particle settling, drift and diffusion to improve display performance and bistability. Sidewalls may be located within the light modulation layer. Sidewalls may completely or partially extend from the front electrode, rear electrode or both the front and rear electrodes. Sidewalls may comprise plastic or glass.

In an exemplary embodiment, a directional front light may be employed with the display embodiments comprising a periodic concentrator overlay. The light source may be a light emitting diode (LED), a cathode fluorescent lamp (CCFL) or a surface mount technology (SMT) incandescent lamp.

In some embodiments a light diffusive layer may be used with the display embodiments comprising a periodic concentrator overlay to “soften” the reflected light observed by the viewer. In other embodiments a light diffusive layer may be used in combination with a front light.

Various control mechanism for the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

In some embodiments, a tangible machine-readable non-transitory storage medium that contains instructions may be used in combination with the reflective displays comprising a periodic concentrator overlay. In other embodiments the tangible machine-readable non-transitory storage medium may be further used in combination with one or more processors.

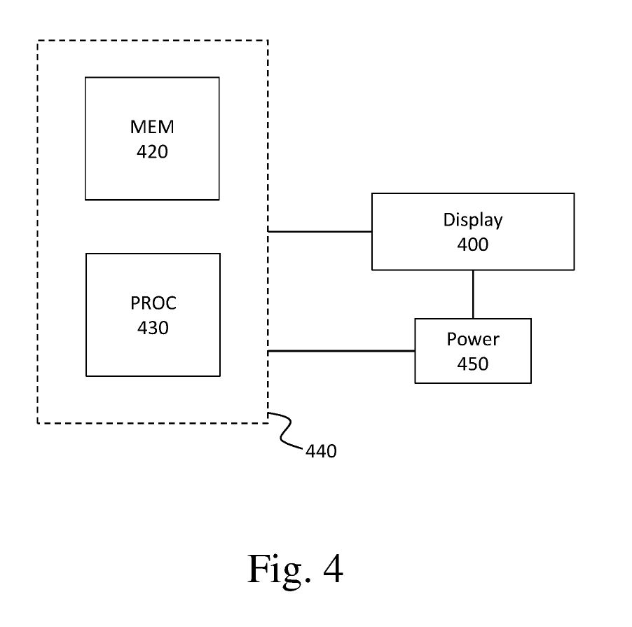

FIG. 4 shows an exemplary system for controlling a display according to one embodiment of the disclosure. In FIG. 4, display 400 is controlled by controller 440 having processor 430 and memory 420. Other control mechanisms and/or devices may be included in controller 440 without departing from the disclosed principles. Controller 440 may define hardware, software or a combination of hardware and software. For example, controller 440 may define a processor programmed with instructions (e.g., firmware). Processor 430 may be an actual processor or a virtual processor. Similarly, memory 420 may be an actual memory (i.e., hardware) or virtual memory (i.e., software).

Memory 420 may store instructions to be executed by processor 430 for driving display 400. The instructions may be configured to operate display 400. In one embodiment, the instructions may include biasing electrodes associated with display 400 (not shown) through power supply 450. When biased, the electrodes may cause movement of electrophoretic particles to a region proximal to a designated color filter(s) to thereby absorb or reflect light received at the color filter. The received light may have been reflected from the first optical filter element (e.g., optical filter element 304, FIG. 3) and received at the color filter (e.g., color filter 314, FIG. 3). In another embodiment, light may be received and passed through an optical filter element (e.g., optical filter element 304, FIG. 3). The incoming rays of light may then be received at a color filter associated with the optical filter element (e.g., color filter 312, FIG. 3). By appropriately biasing the electrodes (not shown), mobile light absorbing particles (e.g., particles 332, FIG. 3) may be summoned to a location at or near the color filter (e.g., color filters 312 or 314, FIG. 3) in order to absorb or reflect the incoming light. Absorbing the incoming light creates a dark state at the color filter location (i.e., the pixel associated with the color filter). Reflecting the incoming light creates a light state at the color filter location (i.e., the pixel associated with the color filter).

In some embodiments, a porous reflective layer may be used in combination with the reflective displays comprising a periodic concentrator overlay. The porous reflective layer may be interposed between the front and rear electrode layers. In other embodiments the rear electrode may be located on the surface of the porous electrode layer.

In the display embodiments described herein, they may be used in such applications such as in, but not limited to, electronic book readers, portable computers, tablet computers, cellular telephones, smart cards, signs, watches, wearables, shelf labels, flash drives and outdoor billboards or outdoor signs comprising a display.

The following exemplary and non-limiting embodiments provide various implementations of the disclosure. Example 1 is directed to a reflective image display device, comprising: a substrate; a plurality of color filters supported by the substrate, the plurality of color filters including a first color filter and a second color filter corresponding to each of a first and a second color, respectively; and a plurality of optical filters arranged relative to the plurality of color filters, each of the plurality of optical filters configured to receive incoming light rays and at least one of (i) pass a first portion of the incoming light rays to the first color filter through the dichroic filter, or (ii) reflect a second portion of the incoming light rays to the second color filter.

Example 2 is directed to the reflective image display device of example 1, wherein the substrate further comprises a light modulation layer to reflect or absorb incoming light rays that have passed through or reflected by the optical filters.

Example 3 is directed to the reflective image display of any of the preceding examples, wherein the light modulation layer is biased by a voltage source to absorb or reflect the portion of the incoming light rays.

Example 4 is directed to the reflective image display of any of the preceding examples, wherein the light modulation layer further comprises electrophoretic particles biased to absorb or reflect light.

Example 5 is directed to the reflective image display of any of the preceding examples, wherein the plurality of optical filters are configured to pass a first portion of the incoming light rays to the first color filter through the optical filter and to reflect a second portion of the incoming light rays to the second color filter.

Example 6 is directed to the reflective image display of any of the preceding examples, wherein a first optical filter is arranged to substantially cover the first color filter.

Example 7 is directed to the reflective image display of any of the preceding examples, wherein a first optical filter is arranged to cover a portion of the first color filter.

Example 8 is directed to the reflective image display of any of the preceding examples, further comprising a third optical filter arranged relative to a third color filter to pass through a third portion of the incoming light rays and to reflect the remaining portion of the incoming light rays.

Example 9 is directed to the reflective image display of any of the preceding examples, wherein the substrate further comprises a plurality of electrophoretically mobile particles suspended in a liquid medium, the electrophoretically mobile particles configured to moved when biased by an external source and in relation to the incoming light rays.

Example 10 is directed to the reflective image display of any of the preceding examples, wherein the optical filter is selected from one or more of dichroic filter, dichroic reflector, interference filter, thin-film filter, photonic crystal component or holographic lens.

Example 11 is directed to the reflective image display of any of the preceding examples, comprising: a first optical filter and a second optical filter arranged to receive an incoming light and to at least one of transmit or to reflect all or a portion of the incoming light; a plurality of color filters supported to communicate light with one or more of the plurality of optical filters, the plurality of color filters including a first color filter and a second color filter corresponding to each of a first and a second color, respectively; a plurality of electrophoretic particles movably positioned proximal to the first color filter and the second color filter; a processor circuitry; and a memory circuitry in communication with the processor circuitry, the memory circuitry including instructions, that when executed, causes the processor circuitry to implement a method comprising: biasing one or more of the plurality of electrophoretically mobile particles to move the one or more particle to a region proximal to the second color filter to thereby or absorb light reflected from the first optical filter and received at the second color filter.

Example 12 is directed to the reflective image display of any of the preceding examples, wherein the memory circuitry further includes instructions for biasing one or more of the plurality of electrophoretically mobile particles to move the one or more particle to a region proximal to the second color filter to thereby reflect light reflected from the first optical filter and received at the second color filter.

Example 13 is directed to the reflective image display of any of the preceding examples, wherein the first optical filter substantially covers that first color filter.

Example 14 is directed to the reflective image display of any of the preceding examples, wherein the first optical filter is adjacent the first color filter.

Example 15 is directed to the reflective image display of any of the preceding examples, further comprising a biasing source.

Example 16 is directed to the reflective image display of any of the preceding examples, wherein the memory circuitry further includes instructions for the processor to bias the first optical filter to absorb a first incoming ray and to bias the plurality of electrophoretically mobile particles to move adjacent to the first color filter to thereby absorb the first incoming ray.

Example 17 is directed to the reflective image display of any of the preceding examples, wherein a method to display an image comprises: receiving light at a first optical filter and one of reflecting light from the optical filter or transmitting light through the optical filter; receiving light reflected by the optical filter at a first color filter; receiving light transmitted through the optical filter at a second color filter; and one of absorbing or reflecting light received at the first filter by biasing a plurality of electrophoretically mobile particles at a region proximal to the first or the second color filters.

Example 18 is directed to the reflective image display of any of the preceding examples, further comprising biasing the plurality of mobile electrophoretic particles to absorb or reflect the portion of the incoming light rays.

Example 19 is directed to the reflective image display of any of the preceding examples, further comprising biasing the plurality of mobile electrophoretic particles to absorb or reflect substantially all of the incoming light rays.

Example 20 is directed to the reflective image display of any of the preceding examples, wherein the optical filter is configured to pass a first portion of the incoming light rays to the first color filter through the optical filter and to reflect a second portion of the incoming light rays to the second color filter.

Example 21 is directed to the reflective image display of any of the preceding examples, further comprising a plurality of optical filters arranged to communicate light to a plurality of color filters.

Example 22 is directed to the reflective image display of any of the preceding examples, wherein a first optical filter is arranged to substantially cover the first color filter.

Example 23 is directed to the reflective image display of any of the preceding examples, wherein a first optical filter is arranged to cover a portion of the first color filter.

Example 24 is directed to the reflective image display of any of the preceding examples, wherein the optical filter is selected from one or more of dichroic filter, dichroic reflector, interference filter, thin-film filter, photonic crystal component or holographic lens.

While the principles of the disclosure have been illustrated in relation to the exemplary embodiments shown herein, the principles of the disclosure are not limited thereto and include any modification, variation or permutation thereof.

What is claimed is:

1. A reflective image display, comprising:
a substrate;
a plurality of color filters supported by the substrate, the plurality of color filters including a first color filter and a second color filter corresponding to each of a first and a second color, respectively;
a plurality of optical filters arranged relative to the plurality of color filters, each of the plurality of optical filters configured to receive incoming light rays and at least one of (i) pass a first portion of the incoming light rays to the first color filter through the dichroic filter, or (ii) reflect a second portion of the incoming light rays to the second color filter.

2. The image display of claim 1, wherein the substrate further comprises a light modulation layer to reflect or absorb incoming light rays that have passed through or reflected by the optical filters.

3. The image display of claim 2, wherein the light modulation layer is biased by a voltage source to absorb or reflect the portion of the incoming light rays.

4. The image display of claim 2, wherein the light modulation layer further comprises electrophoretic particles biased to absorb or reflect light.

5. The image display of claim 1, wherein the plurality of optical filters are configured to pass a first portion of the incoming light rays to the first color filter through the optical filter and to reflect a second portion of the incoming light rays to the second color filter.

6. The image display of claim 1, wherein a first optical filter is arranged to substantially cover the first color filter.

7. The image display of claim 1, wherein a first optical filter is arranged to cover a portion of the first color filter.

8. The image display of claim 1, further comprising a third optical filter arranged relative to a third color filter to pass through a third portion of the incoming light rays and to reflect the remaining portion of the incoming light rays.

9. The image display of claim 1, wherein the substrate further comprises a plurality of electrophoretically mobile particles suspended in a liquid medium, the electrophoretically mobile particles configured to moved when biased by an external source and in relation to the incoming light rays.

10. The image display of claim 1, wherein the optical filter is selected from one or more of dichroic filter, dichroic reflector, interference filter, thin-film filter, photonic crystal component or holographic lens.

11. A reflective image system, comprising:
a first optical filter and a second optical filter arranged to receive an incoming light and to at least one of transmit or to reflect all or a portion of the incoming light;
a plurality of color filters supported to communicate light with one or more of the plurality of optical filters, the plurality of color filters including a first color filter and a second color filter corresponding to each of a first and a second color, respectively;
a plurality of electrophoretic particles movably positioned proximal to the first color filter and the second color filter;
a processor circuitry; and
a memory circuitry in communication with the processor circuitry, the memory circuitry including instructions, that when executed, causes the processor circuitry to implement a method comprising:
biasing one or more of the plurality of electrophoretically mobile particles to move the one or more particle to a region proximal to the second color filter to thereby absorb light reflected from the first optical filter and received at the second color filter.

12. The system of claim 11, wherein the memory circuitry further includes instructions for biasing one or more of the plurality of electrophoretically mobile particles to move the one or more particle to a region proximal to the second color filter to thereby reflect light reflected from the first optical filter and received at the second color filter.

13. The system of claim 11, wherein the first optical filter substantially covers that first color filter.

14. The system of claim 11, wherein the first optical filter is adjacent the first color filter.

15. The system of claim 11, further comprising a biasing source.

16. The system of claim 11, wherein the memory circuitry further includes instructions for the processor to bias the first optical filter to absorb a first incoming ray and to bias the plurality of electrophoretically mobile particles to move adjacent to the first color filter to thereby absorb the first incoming ray.

17. A method to display an image, the method comprising:
receiving light at a first optical filter and one of reflecting light from the optical filter or transmitting light through the optical filter;
receiving light reflected by the optical filter at a first color filter;
receiving light transmitted through the optical filter at a second color filter; and
one of absorbing or reflecting light received at the first filter by biasing a plurality of electrophoretically mobile particles at a region proximal to the first or the second color filters.

18. The method of claim 17, further comprising biasing the plurality of mobile electrophoretic particles to absorb or reflect the portion of the incoming light rays.

19. The method of claim 17, further comprising biasing the plurality of mobile electrophoretic particles to absorb or reflect substantially all of the incoming light rays.

20. The method of claim 17, wherein the optical filter is configured to pass a first portion of the incoming light rays to the first color filter through the optical filter and to reflect a second portion of the incoming light rays to the second color filter.

21. The method of claim 17, further comprising a plurality of optical filters arranged to communicate light to a plurality of color filters.

22. The method of claim 17, wherein a first optical filter is arranged to substantially cover the first color filter.

23. The method of claim 17, wherein a first optical filter is arranged to cover a portion of the first color filter.

24. The method of claim 17, wherein the optical filter is selected from one or more of dichroic filter, dichroic reflector, interference filter, thin-film filter, photonic crystal component or holographic lens.
